(19) United States
(12) Patent Application Publication
(10) Pub. No.: US 2026/0265531 A1
(43) Pub. Date: Sep. 10, 2026

(54) COLLOIDAL SILICA AND METHOD FOR PRODUCING SAME

(71) Applicant: FUSO CHEMICAL CO., LTD., Osaka-shi, Osaka (JP)

(72) Inventors: Haruhiko Eki, Fukuchiyama-shi, Kyoto (JP); Tomoko Shimizu, Fukuchiyama-shi, Kyoto (JP)

(73) Assignee: FUSO CHEMICAL CO., LTD., Osaka-shi, Osaka (JP)

(21) Appl. No.: 18/869,457

(22) PCT Filed: May 31, 2022
(86) PCT No.: PCT/JP2022/022096

§ 371 Date: Nov. 26, 2024

(51) Int. Cl. C09C 1/30

(52) U.S. Cl. CPC C09C 1/3081; C01P 2004/03

(57) ABSTRACT

An object of the present invention is to provide colloidal silica in which a silyl group having one or more amino groups is introduced inside particles and in which the content of fine particles is low. An object of the present invention is to reduce fine particles generated in a shell formation reaction in the production of colloidal silica containing core-shell silica particles in which a silyl group having one or more amino groups is introduced inside the particles. The present invention provides colloidal silica in which a silyl group having one or more amino groups is introduced inside particles, in which the proportion of the number of fine particles contained in the colloidal silica is less than 5% based on the total number of particles, and the density of silanol groups on the surface of the particles of the colloidal silica is 4.0 groups/nm² or less.

### TECHNICAL FIELD

The present invention relates to colloidal silica and a method for producing the same.

### BACKGROUND ART

Silica particles are used as, for example, abrasive grains for chemical polishing (CMP) of semiconductor substrates and the like, fillers for resins, paints for optical materials, external additives for printing toner resin particles, and cosmetic materials. Treatment for introducing functional groups into particles has been widely performed for the purpose of, for example, improving the dispersion stability of the particles and imparting to the particles characteristics according to the intended use. Silane coupling treatment is one such treatment. Typically, in silane coupling treatment, alkoxysilane having a functional group, such as Z—Si(OD)₃, wherein Z represents a functional group and D represents an alkyl group, is used as a silane coupling agent. The alkoxy group of the alkoxysilane reacts with OH groups on the surface of the particles (typically, dehydration-condensation reaction) to form “Z—Si—O-particles,” whereby the functional group Z is introduced into the silica particles. The introduction of the functional group (sometimes referred to as “denaturation”) imparts to the silica particles properties corresponding to the introduced functional group of the silyl group. For example, the introduction of amino groups increases the surface potential of the particles and increases the pH region that shows positive potential.

As a method for introducing amino groups into silica particles, a method is known that includes adding a liquid obtained by mixing tetraalkoxysilane and a silane coupling agent having one or more amino groups to core particles to form shells, thereby producing colloidal silica containing core-shell silica particles into which the amino groups are introduced (PTL 1).

A method is known that includes adding an organic solvent into a reaction liquid in a shell formation reaction, thereby producing colloidal silica containing silica particles having an average primary particle size of 33 nm or more (PTL 2).

A method is known in which colloidal silica is produced under conditions in which the alcohol concentration in a reaction liquid in a silica particle synthesis reaction is high (PTL 3 to 6).

When a large number of fine particles are generated during the stage of forming the shells on the core particles, the removal of fine particles becomes complicated.

### CITATION LIST

### Patent Literature

PTL 1: JP 2016-008157 A
PTL 2: WO 2020/179556
PTL 3: JP 2018-048042 A
PTL 4: JP 2016-094619 A
PTL 5: JP H01-145317 A
PTL 6: JP 562-072514 A
PTL 7: WO 2008/123373
PTL 8: JP 2006-231436 A

### Non-Patent Literature

NPL 1: Kazunori HIRABAYASHI and Atsunori MORI, “Organic Chemistry of Siloxane and Silanol,” Journal of Synthetic Organic Chemistry, Japan, 2000, Vol. 58, No. 10, pp. 926-933

### SUMMARY OF INVENTION

### Technical Problem

The present inventor has confirmed that, according to the method for producing colloidal silica described in PTL 1, a large number of fine particles, i.e., particles having particle sizes smaller than those of core particles, are generated during the stage of forming shells on the core particles (Comparative Example 1 of this application).

In PTL 2, colloidal silica is produced in which the proportion of silica particles having a circular equivalent diameter of less than 20 nm is less than 15%. This effect is obtained by inclusion of an organic solvent (e.g., methanol) in a concentration equal to or higher than a certain concentration in a reaction liquid in the shell formation reaction. Further, PTL 2 does not teach that the number of generated fine particles can be reduced by increasing the proportion of the amount of alkoxysilane added in the shell formation reaction with respect to the amount of an alkaline catalyst added in the shell formation reaction. Additionally, in PTL 2, one or more amino groups are introduced by adding an alkoxysilane having one or more amino groups after forming the shells.

In PTL 3 to 6, it is assumed that the density of silanol groups on the particle surface is high due to the use of a reaction system in which the concentration of an organic solvent (alcohol) in a mixed liquid in a particle synthesis reaction is high, and the present inventor has confirmed that the density of silanol groups is high (Comparative Example 3 of this application). The high density of silanol groups can cause problems, such as instability of silanol groups (section “2. Silanol” on p. 928 of NPL 1), difficulty in forming dense particles having a high true density (paragraphs 0008 to 0011 of PTL 7), and a tendency to be lined to polar groups of a polishing pad and cause clogging of the polishing pad (paragraphs 0010 to 0015 of PTL 8).

Accordingly, an object of the present invention is to provide colloidal silica containing core-shell silica particles in which a silyl group having one or more amino groups is introduced inside the particles, particularly inside the shells and in which the content of fine particles is low.

An object of the present invention is to reduce the fine particles generated in the shell formation reaction in the production of colloidal silica containing core-shell silica particles in which a silyl group having one or more amino groups is introduced inside the particles, particularly inside the shells.

### Solution to Problem

The present inventor has found that the amount of fine particles generated in the shell formation reaction can be reduced without increasing the density of silanol groups of the resultant core-shell silica particles by setting the amount of alkoxysilane (e.g., the total amount of the amount of tetramethyl orthosilicate and the amount of the alkoxysilane having one or more amino groups) added in the reaction of forming the shells on the core particles to 200 times or more in terms of molar ratio with respect to the amount of an alkaline catalyst (e.g., amount of 3-ethoxypropylamine) present in a shell formation reaction liquid, and has accomplished the present invention.

The typical subject matter of the present invention is as follows.

### Item 1.

Colloidal silica in which a silyl group having one or more amino groups is introduced inside particles, in which
the proportion of the number of fine particles contained in the colloidal silica is less than 5% based on the total number of particles, and
the density of silanol groups on the surface of the particles of the colloidal silica is 4.0 groups/nm² or less.

### Item 2.

The colloidal silica according to Item 1, in which the true density is 1.90 or more.

### Item 3.

A method for producing colloidal silica in which a silyl group having one or more amino groups is introduced inside particles, including: a step of allowing an alkoxysilane having one or more amino groups and an alkoxysilane not having an amino group to react with core particles in the presence of an alkaline catalyst to form shells, in which
the total amount of the alkoxysilanes added in a shell formation reaction is 200 times or more in terms of molar ratio with respect to the amount of the alkaline catalyst present in a reaction system in the shell formation reaction.

### Advantageous Effects of Invention

The present invention can provide colloidal silica that contains core-shell silica particles having a density of silanol groups of 4.0 groups/nm² or less and that has a low content of fine particles, and in which a silyl group having one or more amino groups is introduced inside the particles, particularly inside the shells.

The present invention can provide a method for producing colloidal silica in which the total amount of alkoxysilane added in the shell formation reaction is 200 times or more in terms of molar ratio with respect to the amount of alkaline catalyst present in the reaction system in the shell formation reaction.

### BRIEF DESCRIPTION OF DRAWINGS

FIG. 1 is a SEM image of colloidal silica obtained in the final stage of Example 1.

FIG. 2 is a SEM image of colloidal silica obtained in the final stage of Comparative Example 1.

FIG. 3 is a SEM image of colloidal silica dispersed in methanol obtained in the silica particle synthesis reaction of Comparative Example 3.

FIG. 4 is a SEM image of colloidal silica dispersed in water obtained in the final stage of Comparative Example 3.

FIG. 5 is a graph showing the zeta potential measurement results of colloidal silica of Examples 1 to 4 and Comparative Example 1, in which the horizontal axis represents the pH and the vertical axis represents the zeta potential (mV).

### DESCRIPTION OF EMBODIMENTS

In this specification, unless otherwise particularly specified, the expression “inside a particle” means “inside a particle or inside a shell constituting the particle.” For example, the expression “inside a silica particle” means the inside of the silica particle or the inside of a shell constituting the silica particle. The colloidal silica of the present invention is colloidal silica containing core-shell silica particles in which a silyl group having one or more amino groups is introduced inside the particles, having a low content of fine particles, and having a low density of silanol groups on the silica particles. Therefore, the colloidal silica of the present invention is advantageous in that the density of unstable silanol groups is not excessively high, dense particles having a high true density are obtained, and clogging of a polishing pad can be suppressed, for example.

According to the method for producing colloidal silica of the present invention, the amount of alkoxysilane added in a reaction of forming shells on core particles is set to 200 times or more in terms of molar ratio with respect to the amount of an alkaline catalyst (e.g., the amount of 3-ethoxypropylamine) present in a shell formation reaction liquid, and therefore the amount of fine particles generated in the shell formation reaction can be reduced without increasing the density of silanol groups on the core-shell silica particles to be generated.

### 1. Colloidal Silica

The colloidal silica of the present invention has amino groups introduced inside the silica particles contained in the colloidal silica. In particular, the amino groups are distributed throughout the inside of the shells of the core-shell particles contained in the colloidal silica. The proportion of the number of fine particles contained in the colloidal silica is less than 5% based on the total number of particles. The density of silanol groups on the surfaces of the core-shell silica particles contained in the colloidal silica is 4.0 groups/nm² or less.

The colloidal silica of the present invention is typically produced by the production method of the present invention, but may be produced by other methods.

The concentration of the silica particles in the colloidal silica of the present invention can be selected as appropriate by a person skilled in the art depending on the intended use, the planned storage period, and the like of the colloidal silica, but can be set to 1 to 50 mass %, for example.

### Fine Particles

The fine particles refer to particles having a particle size that is 75% or less of the average ellipse minor axis of the silica particles in a SEM image of the colloidal silica. In the present invention, the proportion of the number of fine particles contained in the colloidal silica may be less than 5.0%, preferably 4.0% or less, more preferably 3.0% or less, and even more preferably 2.0% or less based on the total number of particles. Although the lower the proportion, the better, the proportion may be 0.01% or more and less than 5.0%, 0.01 to 3.0%, 0.01 to 2.0%, or the like. The proportion of the number of fine particles contained in the colloidal silica can be determined by the method described in the Examples.

### Density of Silanol Groups

The density of silanol groups on the surfaces of the silica particles contained in the colloidal silica may be 4.0 groups/nm² or less, preferably 3.5 groups/nm² or less, and more preferably 3.0 groups/nm² or less. The density of silanol groups may be 1.0 groups/nm² or more, preferably 1.2 groups/nm² or more, and more preferably 1.4 groups/nm² or more. When the density of silanol groups is equal to or larger than these values, the hydrophobicity of the colloidal silica is not excessively high, and therefore the stability in water is high.

The density of silanol groups may be 1.0 to 4.0 groups/nm², 1.0 to 3.5 groups/nm², 1.0 to 3.0 groups/nm², 1.2 to 4.0 groups/nm², 1.2 to 3.5 groups/nm², 1.2 to 3.0 groups/nm², 1.4 to 4.0 groups/nm², 1.4 to 3.5 groups/nm², 1.4 to 3.0 groups/nm², or the like. The density of silanol groups can be determined by the Sears method described in G. W. Sears, Jr., “Determination of Specific Surface Area of Colloidal Silica by Titration with Sodium Hydroxide,” Analytical Chemistry, 28 (12), 1981 (1956). More specifically, the density of silanol groups can be determined by titration with a 0.1 mol/L aqueous sodium hydroxide solution using a 1 mass % silica dispersion in the Sears method in accordance with the following formula:

ρ=(a×f×6022)/(c×S).

In the formula above, p represents the density of silanol groups (number of silanol groups/nm²), a represents the amount of droplets of the 0.1 mol/L aqueous sodium hydroxide solution having a pH of 4 to 9 (mL), f represents the factor of the 0.1 mol/L aqueous sodium hydroxide solution, c represents the mass of the silica particles (g), and S represents the BET specific surface area (m²/g).

### Average Primary Particle Size

The average primary particle size of the silica particles contained in the colloidal silica is not particularly restricted and can be selected as appropriate depending on the intended use, for example, and is 1 nm or more and preferably 2 nm or more, for example, and 350 nm or less, preferably 150 nm or less, more preferably 120 nm or less, and even more preferably 100 nm or less, for example. The average primary particle size of the silica particles may be 1 nm to 350 nm, 1 nm to 150 nm, 1 nm to 120 nm, 1 nm to 100 nm, 2 nm to 350 nm, 2 nm to 150 nm, 2 nm to 120 nm, or 2 nm to 100 nm. The average primary particle size is determined by the method described in the Examples.

### Average Secondary Particle Size

The average secondary particle size of the silica particles contained in the colloidal silica is not particularly restricted and can be selected as appropriate depending on the intended used, for example, and can be set to 1 nm to 500 nm and 2 nm to 300 nm, and is preferably 3 nm to 250 nm, for example. The average secondary particle size is determined by the method described in the Examples.

### Aggregation Ratio

The aggregation ratio of the silica particles contained in the colloidal silica is represented by Average secondary particle size/Average primary particle size, and is typically 5.0 or less, preferably 4.0 or less, more preferably 3.5 or less, and even more preferably 3.0 or less. The aggregation ratio is 1.0 or more, preferably 1.3 or more, and more preferably 1.5 or more, for example. The aggregation ratio falling within the ranges above makes it easy to suppress the occurrence of scratches on the polishing surface when the particles are used as abrasive grains of abrasives, and makes it easy to improve the polishing rate as compared with that of spherical particles. The aggregation ratio may be 1.0 to 5.0, 1.3 to 5.0, 1.5 to 5.0, 1.0 to 4.0, 1.3 to 4.0, 1.5 to 4.0, 1.0 to 3.5, 1.3 to 3.5, 1.5 to 3.5, 1.0 to 3.0, 1.3 to 3.0, 1.5 to 3.0, or the like, for example.

### Average Ellipse Minor Axis

The average ellipse minor axis of the silica particles contained in the colloidal silica is not particularly restricted and can be selected as appropriate depending on the intended use, for example, and is 1 nm or more and preferably 2 nm or more, for example, and 350 nm or less, preferably 150 nm or less, more preferably 120 nm or less, and even more preferably 100 nm or less, for example. The average ellipse minor axis may be 1 nm to 350 nm, 1 nm to 150 nm, 1 nm to 120 nm, 1 nm to 100 nm, 2 nm to 350 nm, 2 nm to 150 nm, 2 nm to 120 nm, or 2 nm to 100 nm. The average ellipse minor axis is determined by the method described in the Examples.

### Aspect Ratio

The aspect ratio of the silica particles contained in the colloidal silica can be set to 1.0 to 5.0 or 1.0 to 3.0 and is preferably 1.2 to 2.5, for example. An aspect ratio falling within the ranges above makes it easy to suppress the occurrence of scratches on the polishing surface when the particles are used as abrasive grains of abrasives, and makes it easy to improve the polishing rate as compared with that of spherical particles. The aspect ratio is determined by the method described in the Examples.

### Surface Roughness

The surface roughness of the silica particles contained in the colloidal silica can be set to 1.0 to 2.0 or 1.0 to 1.8 and is preferably 1.1 to 1.7, for example. A surface roughness falling within the ranges above is advantageous in terms of polishing performance. The surface roughness is determined by the method described in the Examples.

### True Density

The true density of the silica particles contained in the colloidal silica is 1.60 or more or 1.70 or more, and preferably 1.90 or more and more preferably 2.00 or more, for example, and 2.30 or less, for example. The true density can be set to 1.60 to 2.30, 1.70 to 2.30, 1.90 to 2.30, 2.00 to 2.30, or the like. A true density falling within the ranges above makes it easy to improve the mechanical polishing action and the polishing rate with the particles when the particles are used as abrasive grains of abrasives. The true density is determined by the method described in the Examples.

Amino Group Introduced into Silica Particles

The amino group introduced into the silica particle contained in the colloidal silica may be a group introduced into silica by treating the silica with an alkoxysilane having one or more amino groups. Typically, the introduction refers to a state in which a silyl group having one or more amino groups is linked to the inside of the silica particle by a covalent bond (preferably a siloxane bond), and may be linked, in addition to the covalent bond, by an ionic bond, a hydrogen bond, chemical adsorption, physical adsorption, or the like. The silyl group having one or more amino groups may be linked to a silica particle surface in a similar manner. Therefore, the silica particle has the silyl group having one or more amino groups inside the silica particle. Further, in addition thereto, the silica particle may have the silyl group having one or more amino groups on the particle surface. In one embodiment, the silica particle contained in the colloidal silica of the present invention is a silica particle, in which a silyl group having one or more amino groups is linked to the inside of the silica particle by a covalent bond (preferably a siloxane bond), represented by General Formula (1):

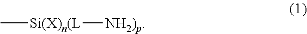

In the formula above, Xs are the same or different and each represents a hydroxyl group, a hydrolyzable substituent, a non-hydrolyzable substituent, a bond to Si of another silyl group through —O—, or a bond to the silicon atom inside the silica particle through —O—, n is 0, 1, or 2, p is an integer of 1 to 3, n+p=3, and L is a linkage group. For example, in the silyl group above, Si in the silyl group is covalently bonded to the silicon atom inside the silica particle through —O—. The Si in the silyl group above may have 1, 2, or 3 bonds through —O—.

### Silyl Group Having One or More Amino Groups Represented by General Formula (1)

When the number of the bonds through —O— between Si in the silyl group represented by General Formula (1) and the silicon atom inside the silica particle is one, —Si in the silyl group is bonded (siloxane bond) to the silicon atom inside the silica particle through —O—. More specifically, Si and the inside of the silica particle are bonded in the form represented by “Si*—O—Si(X)n-,” wherein Si* is the silicon atom inside the silica particle, Xs are the same or different and each represents a hydroxyl group, a hydrolyzable substituent, a non-hydrolyzable substituent, or a bond to Si of another silyl group through —O—, and n is 0, 1, or 2.

When the number of the bonds is two, one of the Xs is “a bond to the silicon atom inside the silica particle through —O—.” More specifically, Si in the silyl group and the silicon atom inside the silica particle are bonded in the form represented by “Si*—O—Si(X)₂(OSi**)₁—,” wherein Si* and X are the same as above, and Si** is the silicon atom inside the silica particle different from Si*.

When the number of the bonds is three, the two Xs are “bonds to the silicon atom inside the silica particle through —O—.” More specifically, Si in the silyl group and the silicon atom inside the silica particle are bonded in the form represented by “Si*—O—Si(X)₁(OSi**)₁(OSi***)₁—,” wherein Si*, Si**, and X are the same as above, and Si*** is the silicon atom inside the particle different from Si* and Si**.

In the silyl group represented by General Formula (1), Xs are the same or different and each represents a hydroxy group, a hydrolyzable substituent, a non-hydrolyzable substituent, a bond to Si of another silyl group through —O—, or a bond to the silicon atom inside the silica particle through —O—.

In X, the hydrolyzable substituent is a group that can be hydrolyzed in an aqueous system to form a Si—OH group. The hydrolyzable group in the alkoxysilane used for the introduction of one or more amino groups remains a hydrolyzable group without being hydrolyzed, is hydrolyzed to form a hydroxy group, or is hydrolyzed to form a hydroxy group and then further condensed with another hydroxy group, for example, depending on the degree of the hydrolysis in the introduction of one or more amino groups, for example. The hydrolyzable substituent is, for example, an alkoxy group, preferably a linear or branched C1-C6 alkoxy group, more preferably a methoxy group, an ethoxy group, a propoxy group, an isopropoxy group, a butoxy group, an isobutoxy group, a sec-butoxy group, or a tert-butoxy group, and even more preferably a methoxy group or an ethoxy group.

In X, the non-hydrolyzable substituent is a group that is not hydrolyzed in an aqueous system, i.e., a group that does not form a Si—OH group. The non-hydrolyzable substituent is, for example, an alkyl group, preferably a linear or branched C1-C6 alkyl group, more preferably a methyl group, an ethyl group, a propyl group, an isopropyl group, a butyl group, an isobutyl group, a sec-butyl group, or a tert-butyl group, and even more preferably a methyl group or an ethyl group.

In X, the bond to Si of another silyl group through —O— is a bond (siloxane bond) between Si in the silyl group represented by General Formula (1) and Si in a silyl group present in the vicinity of Si in the silyl group represented by General Formula (1) through an oxygen atom in the silica particle and forms the Si—O—Si structure.

In X, the bond to the silicon atom inside the silica particle through —O— is a bond between Si in the silyl group and the silica particle and forms the Si—O—Si** structure or the Si—O—Si*** structure, wherein Si** and Si*** are silicon atoms inside the silica particle and are as described above. The details of this bond are as described above.

In one embodiment, Xs are preferably the same or different and each represents a bond to the silicon atom inside the silica particle through —O—, a bond to Si of a silyl group present in the vicinity of the silyl group represented by General Formula (1) through an oxygen atom, a hydroxy group, a methoxy group, an ethoxy group, or a methyl group.

In the silyl group represented by General Formula (1), n is 0, 1, or 2.

In the silyl group represented by General Formula (1), L is a linkage group. The linkage group typically corresponds to a group that is present between Si and a nitrogen atom constituting an amino group in the alkoxysilane having one or more amino groups used in the introduction of one or more amino groups. More specifically, the linkage group links between Si in the silyl group and the nitrogen atom constituting an amino group in the alkoxysilane having one or more amino groups used in the introduction of one or more amino groups. The linkage group is, for example, a linear or branched C1-C18 alkylene group.

The linear or branched C1-C18 alkylene group is a methylene group, an ethylene group, a propylene group, a butylene group, a hexylene group, a decylene group, or an octadecylene group, for example. A branched chain in the branched alkylene group is a C1-C3 alkylene group. The branched chain refers to an alkyl group bonded to a carbon atom constituting a main chain in the branched alkylene group, the main chain representing a linear hydrocarbon chain linking the carbon atom bonded to Si and the nitrogen atom constituting the amino group.

The linear or branched C1-C18 alkylene group may have a substituent. The substituent is an alkenyl group (e.g., vinyl group or allyl group) or an alkynyl group, for example. The substituents may be used alone or in a combination of two or more types thereof. The number of the substituents may be 0, 1, 2, or 3, for example.

The linear or branched C1-C18 alkylene group may contain an oxygen atom (—O—), a nitrogen atom (—N—), or a sulfur atom (—S—) at the end of the alkylene chain or at any position in the alkylene chain. When these heteroatoms are contained in the branched C1-C18 alkylene group, these heteroatoms may be contained in the main chain or in the branched chain. When the nitrogen atom is contained at the end of the alkylene chain or in the alkylene chain, the nitrogen atom may be —NH— or may be substituted with one substituent. The substituent in this case includes a methyl group or an ethyl group. The total number of oxygen atoms, the nitrogen atoms, and the sulfur atoms contained at the end of the alkylene chain and in the alkylene chain is not particularly restricted.

In one embodiment, L is preferably *—(CH₂)₃—O—CH₂—, *—(CH₂)₂—O—CH₂—, *—(CH₂)₃—O—(CH₂)₂—, *—(CH₂)₂—, *—(CH₂)₃—, *—(CH₂)₆—, *—(CH₂)₈—, *—(CH₂)₃—NH—CH₂—, or *—(CH₂)₃—NH—(CH₂)₂—, and is preferably *—(CH₂)₃—O—CH₂—, *—(CH₂)₃—, *—(CH₂)₈—, or *—(CH₂)₃—NH—(CH₂)₂— in terms of easy availability of a silane coupling agent as a raw material and small steric hindrance. The asterisk (*) represents the Si(X)ₙ side.

The silyl group represented by General Formula (1) is preferably a group represented by any of the following formulae due to easy availability of the alkoxysilane having one or more amino groups as a raw material. In the following formulae, Xs are the same as above:

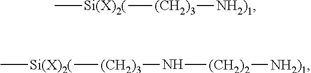

The colloidal silica of the present invention is usable as a physical property improver in the fields of paper, textiles, and iron and steel, for example. In addition, the colloidal silica of the present invention is also usable as abrasives for chemical mechanical polishing (CMP), silicon wafer polishing, and glass polishing. The colloidal silica according to the present invention is also usable as an additive for filler, an external additive for toner, and the like by being dried into powder.

The abrasive containing the colloidal silica may also be one of the subject matter of the present invention. The colloidal silica of the present invention has a reduced content of the fine particles, and therefore can be suitably used as an abrasive for chemical mechanical polishing, particularly an abrasive for chemical mechanical polishing of semiconductor wafers.

### 2. Method for Producing Colloidal Silica

A method for producing colloidal silica containing core-shell silica particles into which amino groups are introduced is known, the method including a step of allowing an alkoxysilane having one or more amino groups and an alkoxysilane not having an amino group to react with core particles in the presence of an alkaline catalyst to form shells on the core particles (shell formation step). The method for producing colloidal silica of the present invention is such that, in the step of forming the shells, the total amount of the alkoxysilanes added in the shell formation reaction is set to 200 times or more in terms of molar ratio with respect to the amount of the alkaline catalyst present in the reaction system in the shell formation reaction. The method for producing colloidal silica of the present invention can reduce the generation of fine particles without increasing the density of silanol groups.

The method for producing colloidal silica of the present invention is suitable for producing the above-described colloidal silica of the present invention.

### Method for Producing Core Particles

The core particles can be produced by conventionally known methods for producing core particles of colloidal silica, and the method is not particularly restricted. For example, core particles can be produced by: (1) preparing a mixed liquid containing an alkaline catalyst and water (Step 1); (2) adding alkoxysilane to the mixed liquid prepared in Step 1 to prepare a mixed liquid (Step 2); and (3) adding an alkaline catalyst to the mixed liquid prepared in Step 2 to prepare silica particles (Step 3).

A method for preparing the mixed liquid containing an alkaline catalyst and water is not particularly limited, and the alkaline catalyst may be added to water and stirred by conventional methods. The pH of the mixed liquid is not particularly limited, and is preferably 9.0 or more and more preferably 9.5 or more.

In the method for producing colloidal silica, the alkaline catalyst is not particularly restricted, and may be at least one amine selected from the group consisting of ammonia, primary amines, secondary amines, and tertiary amines, and is preferably amine represented by General Formula (2) below:

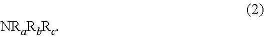

In the formula above, Rₐ, R_{b}, and R_{c} may be the same or different and each represents an optionally substituted C1-C12 alkyl group or a hydrogen atom.

Rₐ, R_{b}, and R_{c} may be the same or different. Rₐ, R_{b}, and R_{c} may be linear or branched.

The number of carbon atoms of a linear or branched alkyl group may be 1 to 12, preferably 1 to 8, and more preferably 1 to 6. The linear alkyl groups include, for example, a methyl group, an ethyl group, a propyl group, a butyl group, a pentyl group, a hexyl group, a heptyl group, an octyl group, and the like. The branched alkyl groups include, for example, an isopropyl group, a 1-methylbutyl group, a 2-methylbutyl group, a 3-methylbutyl group, a 1,1-dimethylpropyl group, a 1,2-dimethylpropyl group, a 2,2-dimethylpropyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 1-methyl-1-ethylpropyl group, a 2-methyl-2-ethylpropyl group, a 1-ethylbutyl group, a 2-ethylbutyl group, a 1-ethylhexyl group, a 2-ethylhexyl group, a 3-ethylhexyl group, a 4-ethylhexyl group, a 5-ethylhexyl group, and the like. Preferable linear or branched alkyl groups include an n-propyl group, an n-hexyl group, a 2-ethylhexyl group, an n-octyl group, and the like.

In Rₐ, R_{b}, and R_{c} in General Formula (2) above, the alkyl groups may be substituted. The number of substituents may be 0, 1, 2, 3, 4, or the like, preferably 0, 1, or 2, and more preferably 0 or 1, for example. An alkyl group having 0 substituents means an unsubstituted alkyl group. The substituents include, for example, alkoxy groups having 1 to 3 carbon atoms (e.g., a methoxy group, an ethoxy group, a propoxy group, and an isopropoxy group), amino groups, primary amino groups substituted with linear alkyl groups having 1 to 4 carbon atoms, amino groups di-substituted with linear alkyl group having 1 to 4 carbon atoms (e.g., a dimethylamino group and a di-n-butylamino group), unsubstituted amino groups, and the like. However, a hydroxyl group is excluded from the substituents. In alkyl groups having a plurality of substituents, the substituents may be the same or different.

In one embodiment, Rₐ, R_{b}, and R_{c} are the same or different and each represents an unsubstituted linear or branched C1-C12 alkyl group, a linear or branched C1-C12 alkyl group substituted with an alkoxy group, or a hydrogen atom.

In another embodiment, Rₐ, R_{b}, and R_{c} are the same or different and each represents an unsubstituted linear or branched C1-C8 alkyl group, a linear or branched C1-C8 alkyl group substituted with a C1-C3 alkoxy group, or a hydrogen atom.

In another embodiment, Rₐ, R_{b}, and R_{c} are the same or different and each represents an unsubstituted linear or branched C1-C6 alkyl group, a linear or branched C1-C6 alkyl group substituted with a C1-C3 alkoxy group, or a hydrogen atom.

In one embodiment, two of Rₐ, R_{b}, and R_{c} are hydrogen atoms and the remaining one represents an unsubstituted linear or branched C1-C12 alkyl group or a linear or branched C1-C12 alkyl group substituted with an alkoxy group.

In another embodiment, two of Rₐ, R_{b}, and R_{c} are hydrogen atoms and the remaining one represents an unsubstituted linear or branched C1-C8 alkyl group or a linear or branched C1-C8 alkyl group substituted with a C1-C3 alkoxy group.

In another embodiment, two of Rₐ, R_{b}, and R_{c} are hydrogen atoms and the remaining one represents an unsubstituted linear or branched C1-C6 alkyl group or a linear or branched C1-C6 alkyl group substituted with a C1-C3 alkoxy group.

In another embodiment, Rₐ, R_{b}, and R_{c} all represent hydrogen atoms.

The alkaline catalyst includes at least one selected from the group consisting of ammonia, 3-ethoxypropylamine, pentylamine, hexylamine, dipropylamine, and triethylamine.

Among the above, ammonia, 3-ethoxypropylamine, dipropylamine, and triethylamine are more preferable. To further improve the storage stability of the colloidal silica, 3-ethoxypropylamine is preferable.

The alkaline catalysts may be used alone or in a combination of two or more types thereof. As the alkaline catalyst, the amines described above for the colloidal silica may be used.

### Shell Formation Step

The step of forming a shell on the core particle involves a shell formation reaction, and includes adding alkoxysilane to form the shell. The total amount of the alkoxysilanes added in the shell formation reaction is set to 200 times or more in terms of molar ratio with respect to the amount of the alkaline catalyst present in the reaction system in the shell formation reaction.

The shell can be formed by adding alkoxysilane to core particles dispersed in a mixed liquid of water and the alkaline catalyst to cause a reaction. In this step, the alkaline catalyst may be added to adjust the amount of the alkaline catalyst. The core particles used in the shell formation step are preferably dispersed in the mixed liquid of water and the alkaline catalyst.

The shell formation step may be Step (a) of mixing the core particles, the alkaline catalyst, and the alkoxysilane in any order in the presence or absence of water and/or an organic solvent, for example.

In the shell formation step and Step (a), a mixture is prepared by mixing the core particles, the alkaline catalyst, and the alkoxysilane in any order in the presence or absence of water and/or an organic solvent. Stirring can be optionally performed in any stage before, during, or after the mixing. The stirring method is not particularly restricted.

### Alkaline Catalyst

As the alkaline catalyst, the alkaline catalysts described in the above-described method for producing core particles are usable. In the shell formation reaction, the amount (molar amount) of the alkaline catalyst present in the reaction system is set to one over 200 or less of the total molar amount of the alkoxysilane added in the shell formation reaction. The alkaline catalyst may be added in the shell formation reaction insofar as the amount is within the range of one over 200 or less of the total molar amount of the alkoxysilane. The amount (molar amount) of the alkaline catalyst present in the shell formation reaction system is preferably one over 200 or less and more preferably one over 250 or less of the total molar amount of the alkoxysilane added in the shell formation reaction. The amount of the alkaline catalyst present in the shell formation reaction system may be one over 5000 to one over 200, one over 4000 to one over 200, one over 3000 to one over 200, one over 5000 to one over 250, one over 4000 to one over 250, or one over 3000 to one over 250 of the total molar amount of the alkoxysilane added in the shell formation reaction. The amount of the alkaline catalyst present in the shell formation reaction system falling within the ranges above makes it possible to more effectively suppress the generation of the fine particles.

The production method of the present invention is a method for producing colloidal silica in which a silyl group having one or more amino groups is introduced inside particles, and therefore the alkoxysilane having one or more amino groups and the alkoxysilane not having an amino group are used in the shell formation step.

In the shell formation step, the total amount of the alkoxysilanes added in the shell formation reaction (total amount of the amount of the alkoxysilane having one or more amino groups and the amount of the alkoxysilane not having an amino group) is 200 times or more and preferably 250 times or more in terms of molar ratio with respect to the amount of the alkaline catalyst present in the shell formation reaction system. The total amount of the alkoxysilanes to be added may be 200 to 5000 times, 200 to 4000 times, 200 to 3000 times, 250 to 4000 times, and 250 to 3000 times based on the amount of the alkaline catalyst present in the shell formation reaction system. The total amount of the alkoxysilanes to be added in the shell formation reaction falling within the ranges above makes it possible to more effectively suppress the generation of the fine particles.

In the shell formation reaction, the total amount of the alkoxysilanes to be added is not particularly restricted insofar as the colloidal silica of the present invention is obtained, and is preferably 0.5 molar amount or more, more preferably 0.5 to 200 molar amount, and even more preferably 0.5 to 120 molar amount per molar amount of the core particles.

In the alkoxysilane to be added in the shell formation step, the amount of the alkoxysilane having one or more amino groups is not particularly restricted insofar as the colloidal silica of the present invention is obtained, and is preferably 0.1 to 10 mol % and more preferably 0.2 to 5 mol % based on the total amount (100 mol %) of the alkoxysilane.

### Alkoxysilane Having One or More Amino Groups

The alkoxysilane having one or more amino groups is not particularly limited, and alkoxysilane represented by General Formula (3) below, for example, is usable:

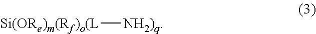

In the formula above, Rₑ represents an alkyl group, L represents a linkage group, m is an integer of 1 to 3, o is an integer of 0 to 2, q is an integer of 1 to 3, and m+o+q=4.

Rₑ is not particularly limited insofar as it is an alkyl group, and is preferably a linear or branched C1-C8 alkyl group, more preferably a linear C1-C8 alkyl group, and even more preferably a linear C1-C4 alkyl group. Specific examples of the alkyl group include a methyl group, an ethyl group, a propyl group, an isopropyl group, a butyl group, a pentyl group, a hexyl group, and the like, with a methyl group and an ethyl group being preferable.

R_{f} is not particularly limited insofar as it is an alkyl group, and is preferably a linear or branched C1-C8 alkyl group, more preferably a linear C1-C8 alkyl group, and even more preferably a linear C1-C4 alkyl group. Specific examples of the alkyl group include a methyl group, an ethyl group, a propyl group, an isopropyl group, a butyl group, a pentyl group, a hexyl group, and the like, with a methyl group and an ethyl group being preferable.

L is a linkage group and corresponds to the linkage group in the silyl group having one or more amino groups represented by General Formula (1) above. Therefore, unless otherwise particularly specified, the description above for L in the silyl group having one or more amino groups represented by General Formula (1) applies to L in General Formula (3).

The alkoxysilane having one or more amino groups includes aminopropyltrimethoxysilane, aminopropyltriethoxysilane, aminopropyldimethylethoxysilane, (aminoethyl)aminopropyltrimethoxysilane, (aminoethyl)aminopropyltriethoxysilane, aminopropylmethyldiethoxysilane, (aminoethyl)aminopropylmethyldimethoxysilane, aminobutyltriethoxysilane, and the like, with aminopropyltrimethoxysilane, aminopropyltriethoxysilane, and (aminoethyl)aminopropyltriethoxysilane being preferable.

The alkoxysilanes having one or more amino groups may be used alone or in a combination of two or more types thereof. The alkoxysilane having one or more amino groups may be added all at one time or in divided portions (e.g., two times or three times).

### Alkoxysilane not Having an Amino Group

The alkoxysilane not having an amino group is not particularly limited, and includes alkoxysilane represented by General Formula (4A) below:

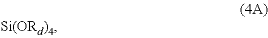

wherein R_{d} represents an alkyl group, or alkoxysilane represented by General Formula (4B) below:

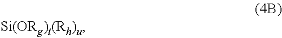

wherein R_{g} represents an alkyl group, Rₕ represents an alkyl group, t is an integer of 1 to 3, u is an integer of 1 to 3, and t+u=4.

In General Formula (4A) above, R_{d} represents an alkyl group. R_{d} is not particularly limited insofar as it is an alkyl group, and is preferably a linear or branched C1-C8 alkyl group, more preferably a linear C1-C8 alkyl group, and even more preferably a linear C1-C4 alkyl group. Specific examples of the alkyl group include a methyl group, an ethyl group, a propyl group, an isopropyl group, a butyl group, a pentyl group, a hexyl group, and the like. The alkoxysilane represented by General Formula (4A) above is preferably tetramethoxysilane (also known as tetramethylorthosilicate) in which R_{d} is a methyl group, tetraethoxysilane (also known as tetraethylorthosilicate) in which R_{d} is an ethyl group, or tetraisopropoxysilane in which R_{d} is an isopropyl group, more preferably tetramethoxysilane in which R_{d} is a methyl group or tetraethoxysilane in which R_{d} is an ethyl group, and even more preferably tetramethoxysilane.

In General Formula (4B) above, R_{g} and Rₕ are the same or different and each represents an alkyl group. R_{g} and Rₕ are not particularly limited insofar as R_{g} and Rₕ are alkyl groups, and are preferably linear or branched C1-C8 alkyl groups, more preferably linear C1-C8 alkyl groups, and even more preferably linear C1-C4 alkyl groups. Specific examples of the alkyl group include a methyl group, an ethyl group, a propyl group, an isopropyl group, a butyl group, a pentyl group, a hexyl group, and the like, with a methyl group, an ethyl group, and an n-propyl group being preferable and a methyl group and an ethyl group being more preferable. The alkoxysilane represented by General Formula (4B) above is even more preferably methyltrimethoxysilane, dimethyldimethoxysilane, methyltriethoxysilane, dimethyldiethoxysilane, ethyltrimethoxysilane, diethyldimethoxysilane, ethyltriethoxysilane, diethyldiethoxysilane, n-propyltrimethoxysilane, and n-propyltriethoxysilane.

The alkoxysilanes not having an amino group may be used alone or in a combination of two or more types thereof. The alkoxysilane not having an amino group may be added all at one time or in divided portions (e.g., two times or three times).

The alkoxysilane having one or more amino groups and the alkoxysilane not having an amino group may be derivatives. Examples of the derivatives of the alkoxysilanes include low condensates obtained by partially hydrolyzing the alkoxysilane having one or more amino groups and the alkoxysilane not having an amino group.

The alkoxysilane having one or more amino groups and the alkoxysilane not having an amino group may be added separately or mixed together.

### Medium

The shell formation step can be carried out in the presence or absence of water and/or an organic solvent (sometimes simply referred to as a “medium” below). To suppress aggregation, it is advantageous and preferable to carry out the shell formation step in the presence of a medium. When a medium is used, the usage amount of the medium is not particularly restricted insofar as the shell is formed.

The medium is preferably water alone or a combination of water and an organic solvent. The use of water improves the reactivity of the alkoxysilane, and is thus preferable. The organic solvent is not particularly restricted insofar as the colloidal silica of the present invention is obtained. Examples include alcohols, such as methanol, ethanol, and 2-propanol, with methanol and ethanol being preferable. The ratio of water to the organic solvent is such that, for example, the amount of water is 30 mass parts or more, preferably 40 mass parts or more, and more preferably 50 mass parts or more, and also such that, for example, the amount of water is 100 mass parts or less and preferably 95 mass parts or less based on 100 mass parts of the total of water and the organic solvent. The ratio of water to the organic solvent can also be such that, for example, the amount of water is 30 to 100 mass parts, 40 to 100 mass parts, 50 to 100 mass parts, 30 to 95 mass parts, 40 to 95 mass parts, and 50 to 95 mass parts based on 100 mass parts of the total of water and the organic solvent. The use of a higher usage ratio of water is advantageous in terms of production costs.

In one embodiment, the required amount of the alkaline catalyst is added to water containing core particles, and then the alkoxysilane is added and heated to form the shells. When the water containing core particles contains the required amount of the alkaline catalyst, the addition of the alkaline catalyst is not required.

In the shell formation reaction, the time required for the addition of the alkoxysilane is not particularly restricted insofar as the colloidal silica of the present invention is obtained.

The temperature of the reaction liquid in the shell formation reaction is not particularly restricted insofar as the colloidal silica of the present invention is obtained, and is preferably 70° C. or higher and more preferably 75° C. or higher. The lower limit of the temperature of the mixed liquid falling within the ranges above makes it difficult to cause gelation in the reaction. The temperature of the mixed liquid is preferably 95° C. or lower and more preferably 90° C. or lower. The upper limit of the temperature of the mixed liquid falling within the ranges above makes it difficult to vaporize the alkoxysilane. The temperature of the reaction liquid may be 70 to 95° C., 75 to 95° C., 70 to 90° C., or 75 to 90° C.

The colloidal silica obtained in the shell formation step may be concentrated or diluted as required, and, for example, the silica particle concentration can be set to 1 to 50 mass %. The concentration method is not particularly limited, and the colloidal silica can be concentrated by conventionally known methods. Such a concentration method includes a method for heating and concentrating the colloidal silica at a temperature of about 65 to 100° C., for example.

When an organic solvent is used as the medium, the colloidal silica obtained in the shell formation step contains the organic solvent, such as alcohol. Therefore, the organic solvent may be distilled out of the system. The method for distilling the organic solvent out of the system is not particularly limited, and includes a method in which pure water is added dropwise to the colloidal silica while heating the colloidal silica, and the volume is kept constant, thereby replacing a dispersion medium with the pure water. Examples of the other methods include a method in which the colloidal silica is separated by precipitation or separated from a solvent by centrifugation or the like, and then redispersed in water; or a method in which pure water is added while the organic solvent is removed by ultrafiltration and the solvent is replaced with the water.

### EXAMPLES

Hereinafter, the present invention is specifically described with reference to Examples, for example; however, the present invention is not limited thereto.

### Example 1

### Production of Core Particles

### Step 1

In a flask, 7500 g of pure water as a solvent was placed, and 0.7737 g of 3-ethoxypropylamine as the alkaline catalyst was added to prepare a mixed liquid. The pH of the mixed liquid was 10.7. The 0.7737 g of 3-ethoxypropylamine is used in the synthesis of core particles, and therefore is not contained in the amount of the alkaline catalyst used to form shells.

### Step 2

The mixed liquid was heated so that the internal temperature reached 85° C., and 2740 g of tetramethyl orthosilicate (TMOS) was poured into the mixed liquid at a constant rate over 60 minutes while the temperature was adjusted so that the internal temperature did not fluctuate. After the pouring was completed, the resultant mixed liquid was stirred for 60 minutes to prepare a mixed liquid.

### Step 3

To the mixed liquid, 10.0 g of 3-ethoxypropylamine (3-EOPA) was added to prepare colloidal silica (dispersion containing core particles; 10250.8 g). The colloidal silica had a silica concentration of 10.5 mass %, and the secondary particle size of the silica particles in the colloidal silica was 36 nm.

### Shell Formation

### Step 4

In a flask, 5882 g of pure water as a solvent and 2604 g of the dispersion containing core particles prepared in Step 3 (containing 2.540 g (0.02462 mol) of the 3-EOPA added in Step 3) were placed and mixed to prepare a mixed liquid. In this step, the 3-ethoxypropylamine as the alkaline catalyst was not added.

### Step 5

The mixed liquid prepared in Step 4 was heated to 80° C., and a mixed liquid of 1872.3 g (12.3000 mol) of tetramethyl orthosilicate and 16.3 g (0.0909 mol) of 3-aminopropyltrimethoxysilane (3-APTMS) was poured at a constant rate over 180 minutes while the temperature was adjusted so that the liquid temperature did not fluctuate. After the pouring was completed, the liquid temperature was kept at 80° C. for 15 minutes, and shells were formed to give a colloidal silica dispersion containing core-shell silica particles. The total amount of the alkoxysilanes added in the shell formation reaction was 503 times in molar ratio with respect to the amount of the alkaline catalyst (=(12.3000+0.0909)/0.02462).

### Concentration and Water Replacement

### Step 6

The colloidal silica dispersion obtained in Step 5 was collected in an amount of 900 g as a base amount and collected in an amount of 900 g as a feed amount, the colloidal silica dispersion was fed while the volume was kept constant under normal pressure, and the resultant colloidal silica dispersion was heated and concentrated until the silica concentration reached about 20 mass %. Next, to distill methanol out of the system, 670 mL of pure water was added dropwise while the volume was kept constant to replace the dispersion medium, preparing colloidal silica dispersed in water.

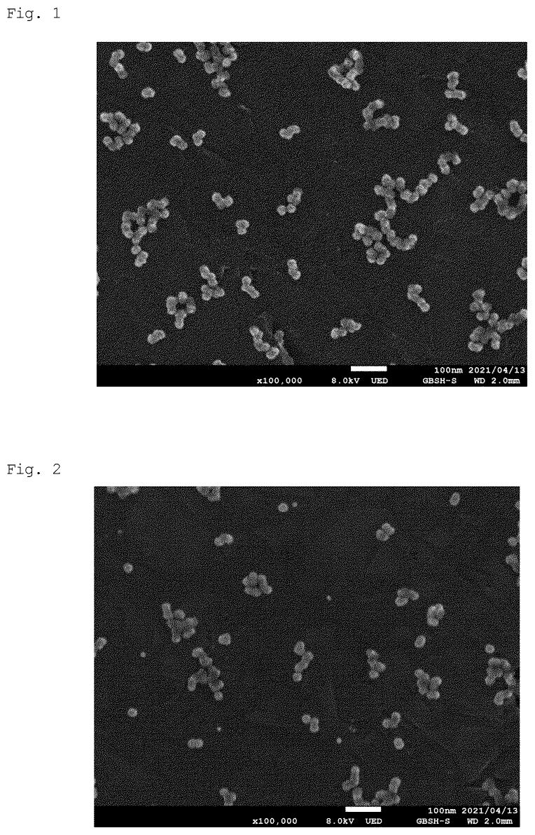

The observation of the obtained colloidal silica by a SEM image analysis method described later showed that few fine particles were found (FIG. 1).

### Example 2

Colloidal silica dispersed in water was prepared in the same manner as in Example 1, except that 2.536 g of 3-ethoxypropylamine as the alkaline catalyst was added in Step 4 of Example 1. The total amount of the alkoxysilanes added in the shell formation reaction was 252 times in terms of molar ratio with respect to the amount of the alkaline catalyst.

### Comparative Example 1

This example is equivalent to Example 1 described in JP 2016-008157 A.

Colloidal silica dispersed in water was prepared in the same manner as in Example 1, except that 10.144 g of 3-ethoxypropylamine as the alkaline catalyst was added in Step 4 of Example 1. The mixed liquid obtained in Step 4 had a pH of 10. The total amount of the alkoxysilanes added in the shell formation reaction was 101 times in molar ratio with respect to the amount of the alkaline catalyst.

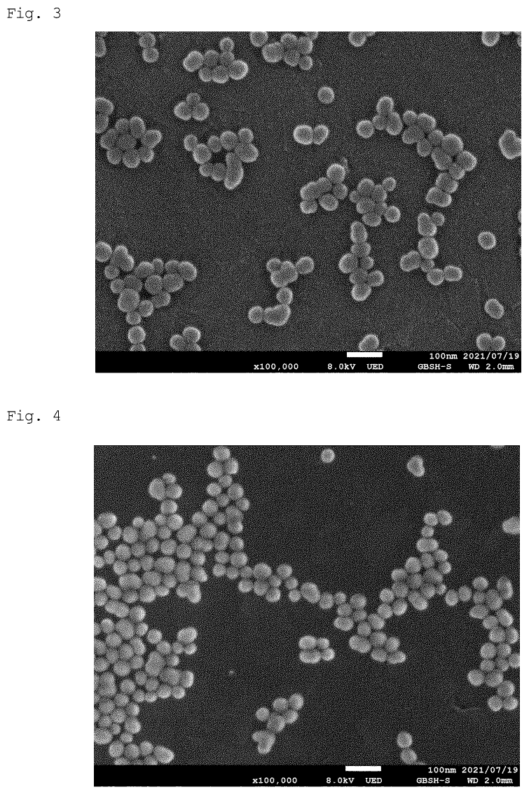

The observation of the obtained colloidal silica dispersed in water by the SEM image analytical method described later (FIG. 2) showed that the colloidal silica (average ellipse minor axis of 27 nm) of Comparative Example 1 clearly contained a larger number of fine particles having a particle size of 20 nm (27 nm×0.75=20 nm) or less as compared with the number of fine particles of the colloidal silica (average ellipse minor axis of 27 nm) (FIG. 1) of Example 1.

### Example 3

Colloidal silica dispersed in water was prepared in the same manner as in Example 1, except that Steps 4 and 5 below were performed in place of Steps 4 and 5 of Example 1. The total amount of the alkoxysilanes added in the shell formation reaction was 1007 times in terms of molar ratio with respect to the amount of the alkaline catalyst.

### Step 4

In a flask, 6061 g of pure water, 930 g of methanol, 581 g of the dispersion containing core particles prepared in Step 3 of Example 1, and 0.789 g of 3-ethoxypropylamine (3-EOPA) were placed and mixed to prepare a mixed liquid.

### Step 5

The mixed liquid prepared in Step 4 was heated to 80° C., and then a mixed liquid of 2000 g of tetramethyl orthosilicate, 800 g of methanol, and 17.4 g of 3-aminopropyltrimethoxysilane was poured at a constant rate over 360 minutes while the temperature was adjusted so that the liquid temperature did not fluctuate. After the pouring was completed, the liquid temperature was kept at 80° C. for 15 minutes to give a colloidal silica dispersion containing core-shell silica particles.

### Example 4

Colloidal silica dispersed in water was prepared in the same manner as in Example 3, except that the usage amount of 3-ethoxypropylamine was changed to 2.144 g in Step 4 of Example 3. The total amount of the alkoxysilanes added in the shell formation reaction was 504 times in terms of molar ratio with respect to the amount of the alkaline catalyst.

### Comparative Example 2

Colloidal silica dispersed in water was prepared in the same manner as in Example 3, except that the usage amount of 3-ethoxypropylamine was changed to 8.761 g in Step 4 of Example 3. The total amount of the alkoxysilanes added in the shell formation reaction was 146 times in terms of molar ratio with respect to the amount of the alkaline catalyst.

### Comparative Example 3

This example is equivalent to Example 2 described in JP 2018-048042 A.

Under normal temperature and normal pressure, 1316 g of tetramethyl orthosilicate, 13.333 g of 3-aminopropyltriethoxysilane, and 352 g of methanol were mixed to give a composition.

A reaction vessel was charged with 805 g of aqueous ammonia solution (28 mass %), 1298 g of water, and 10417 g of methanol, followed by stirring at 35° C. at 200 rpm, and then the composition above was gradually added over 30 minutes to prepare a colloidal silica dispersion. The observation of the obtained colloidal silica (colloidal silica after the shell formation reaction) by the SEM image analysis method described later showed that an excessively large number of fine particles were found (FIG. 3).

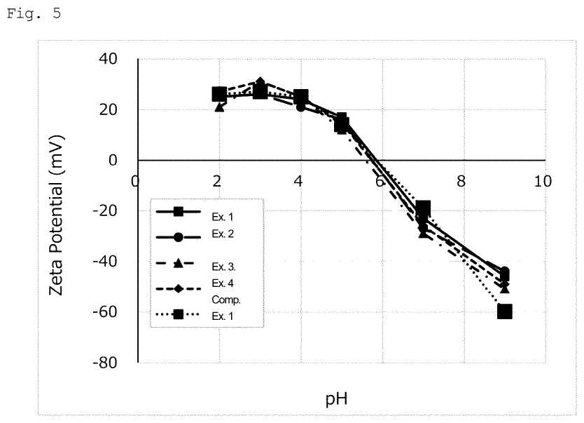

Next, colloidal silica dispersed in water was prepared in the same manner as in Step 6 of Example 1, except that the base amount was set to 800 g, the feed amount was set to 1800 g, and the amount of pure water to replace methanol was set to 1200 mL. The total amount of the alkoxysilanes added in the particle synthesis reaction was 0.658 times in terms of molar ratio with respect to the amount of the alkaline catalyst. The observation of the obtained colloidal silica dispersed in water by SEM showed that fine particles (FIG. 3) observed after the particle synthesis reaction were taken into the silica particles and decreased (FIG. 4).

The shell formation reaction conditions and the physical properties of the particles after the shell formation reaction of Examples 1 to 4 and Comparative Examples 1 to 2 are shown in Table 1, and those of Comparative Example 3 are shown in Table 2. The physical properties, for example, of the colloidal silica dispersed in water prepared in each of the Examples and Comparative Examples above were measured by the methods described below, and the results are shown in Table 3.

TABLE 1

| Shell formation reaction conditions or physical | | | | | Comp. | | | Comp. |
|---|---|---|---|---|---|---|---|---|
| properties of particles | | Unit | Ex. 1 | Ex. 2 | Ex. 1 | Ex. 3 | Ex. 4 | Ex. 2 |
| Reaction | Type of alkaline catalyst in | — | 3-EOPA | 3-EOPA | 3-EOPA | 3-EOPA | 3-EOPA | 3-EOPA |
| conditions | dispersion of Step 3 | | | | | | | |
| | Amount of alkaline catalyst in | g | 2.540 | 2.540 | 2.540 | 0.567 | 0.567 | 0.567 |
| | dispersion of Step 3 | | | | | | | |
| | Type of alkaline catalyst added in | — | 3-EOPA | 3-EOPA | 3-EOPA | 3-EOPA | 3-EOPA | 3-EOPA |
| | Step 4 | | | | | | | |
| | Addition amount of alkaline | g | 0 | 2.536 | 10.144 | 0.789 | 2.144 | 8.761 |
| | catalyst in Step 4 | | | | | | | |
| | Total amount of alkaline catalyst | mol | 0.0246 | 0.0492 | 0.1229 | 0.0131 | 0.0263 | 0.0904 |
| | in shell formation reaction | | | | | | | |
| | Type of alkoxysilane in Step 5 | — | TMOS | TMOS | TMOS | TMOS | TMOS | TMOS |
| | | | 3-APTMS | 3-APTMS | 3-APTMS | 3-APTMS | 3-APTMS | 3-APTMS |
| | Total amount of alkoxysilane in | mol | 12.39 | 12.39 | 12.39 | 13.24 | 13.24 | 13.24 |
| | Step 5 | | | | | | | |
| | Molar ratio of | — | 503 | 252 | 101 | 1007 | 504 | 146 |
| | alkoxysilane/alkaline catalyst in | | | | | | | |
| | shell formation reaction | | | | | | | |
| | Methanol concentration in mixed | wt % | 7 | 7 | 7 | 14 | 14 | 14 |
| | liquid before starting shell | | | | | | | |
| | formation reaction (addition of | | | | | | | |
| | alkoxysilane) | | | | | | | |
| Physical | Average ellipse minor axis | nm | 24 | 25 | 25 | 50 | 49 | 49 |
| properties of | 75% diameter of average ellipse | nm | 18 | 19 | 19 | 38 | 37 | 37 |
| particles after | minor axis | | | | | | | |
| reaction | Proportion of number of fine | % | 2.1 | 3.4 | 7.7 | 3.1 | 1.1 | 5.8 |
| | particles | | | | | | | |

TABLE 2

| Particle synthesis reaction conditions or physical properties of particles | | Unit | Comp. Ex. 3 |
|---|---|---|---|
| Reaction conditions | Molar ratio of alkoxysilane/alkaline catalyst | — | 0.658 |
| | Methanol concentration in mixed liquid | wt % | 83 |
| | before starting addition of alkoxysilane | | |
| Physical properties | Average ellipse minor axis | nm | Unmeasurable due |
| of particles after | 75% diameter of average ellipse minor axis | nm | to many fine |
| reaction | Proportion of number of fine particles | % | particles |

TABLE 3

| | | | | Comp. | | | Comp. | Comp. |
|---|---|---|---|---|---|---|---|---|
| Physical properties of particles | Unit | Ex. 1 | Ex. 2 | Ex. 1 | Ex. 3 | Ex. 4 | Ex. 2 | Ex. 3 |
| BET specific surface area | m²/g | 115 | 115 | 115 | 69 | 69 | 68 | 81 |
| Average primary particle size | nm | 23.7 | 23.7 | 23.7 | 39.6 | 39.7 | 40.1 | 33.5 |
| Average secondary particle size | nm | 58 | 56 | 56 | 77 | 76 | 76 | 53 |
| Aggregation ratio | — | 2.4 | 2.3 | 2.4 | 1.9 | 1.9 | 1.9 | 1.6 |
| Average ellipse minor axis | nm | 27 | 27 | 27 | 47 | 48 | 45 | 38 |
| 75% diameter of average ellipse | nm | 20 | 20 | 20 | 35 | 36 | 34 | 29 |
| minor axis | | | | | | | | |
| Proportion of number of fine | % | 0.4 | 1.8 | 6.7 | 1.4 | 1.6 | 10.9 | 1.1 |
| particles | | | | | | | | |
| Aspect ratio | — | 1.8 | 1.7 | 1.8 | 1.5 | 1.4 | 1.4 | 1.3 |
| Surface roughness | — | 1.1 | 1.1 | 1.1 | 1.2 | 1.2 | 1.1 | 1.1 |
| Density of silanol groups | groups/nm² | 1.8 | 1.7 | 1.7 | 2.8 | 2.8 | 2.1 | 6.1 |
| True density | — | 2.10 | 2.10 | 2.10 | 2.07 | 2.06 | 2.06 | 1.87 |

### Zeta Potential of Colloidal Silica

To confirm that amino groups are contained in the silica particles, the zeta potential of the silica particles was measured. The results are shown in Table 4 and FIG. 5. The zeta potential of the Comparative Example in this application was equivalent to that of Example 1 of PTL 1 (JP 2016-008157 A). The zeta potentials at pH of 2 of Examples 1 to 4 were all about 25 mV, all of which were equivalent to that of Comparative Example 1 of this application. In Comparative Example 1 described in JP 2016-008157 A containing amino groups only on the particle surface, the zeta potential at the pH of 2 is as high as about 45 mV. From these findings, it can be confirmed that the silica particles in the colloidal silica of each of Examples 1 to 4 of this application have both the silanol groups and the amino groups on the surfaces.

TABLE 4

| | | | | | Comp. |
|---|---|---|---|---|---|
| | Ex. 1 | Ex. 2 | Ex. 3 | Ex. 4 | Ex. 1 |
| Zeta potential at pH of 2 | +25 mV | +25 mV | +21 mV | +27 mV | +26 mV |
| Zeta potential at pH of 3 | +26 mV | +26 mV | +31 mV | +31 mV | +27 mV |
| Zeta potential at pH of 4 | +24 mV | +21 mV | +25 mV | +25 mV | +25 mV |
| Zeta potential at pH of 5 | +17 mV | +16 mV | +12 mV | +15 mV | +14 mV |
| Zeta potential at pH of 7 | −23 mV | −27 mV | −29 mV | −26 mV | −19 mV |
| Zeta potential at pH of 9 | −46 mV | −44 mV | −51 mV | −49 mV | −60 mV |

### Method for Determining Physical Properties

The physical properties, for example, in Table 3 were determined as follows.

### 1. BET Specific Surface Area and Average Primary Particle Size

The colloidal silica was dried on a hot plate, and then heat-treated at 800° C. for 1 hour to prepare a measurement sample. The prepared measurement sample was measured for the BET specific surface area (m²/g) by a nitrogen gas adsorption method (BET method).

The average primary particle size (nm) of the silica particles in the colloidal silica was determined by converting the value of 2727/BET specific surface area (m²/g) from the measurement values of the BET specific surface area above with the true specific gravity of the silica taken as 2.2.

### 2. Average Secondary Particle Size

The colloidal silica was added to a 0.3 wt % aqueous citric acid solution and homogenized to prepare a measurement sample. The measurement sample was used to measure the secondary particle size of the silica particles of the colloidal silica by dynamic light scattering (ELSZ-2000S, manufactured by Otsuka Electronics Co., Ltd.).

### 3. Aggregation Ratio

The aggregation ratio of the silica particles of the colloidal silica was determined by calculating the average secondary particle size/average primary particle size of the silica particles of the colloidal silica.

### 4. Analysis of SEM Image

### 4-1. Preparation of Sample for SEM Observation

Onto a sample stage, 10 μL of a liquid obtained by mixing 7.5 mL of methanol, 1.5 mL of water, 1 mL of 0.01M HCl, and 5 μL of colloidal silica having a silica concentration of 20% or a reaction liquid having a silica concentration after the shell formation reaction of 7 to 12% was dropped and dried. When the mixed liquid above was prepared, the amount of the dispersion containing silica particles may be increased or decreased so that the silica concentration after dilution and mixing was 0.007 to 0.012 mass %. This sample stage is set in a scanning electron microscope (SEM), and a SEM image is taken. The white bar shown at the bottom of the SEM image indicates a length of 100 nm.

### 4-2. Average Ellipse Minor Axis

The image of the silica particles taken with the scanning electron microscope was used to approximate 1000 particles into ellipses using image analysis software (WinRoof 2015, manufactured by Mitani Corporation), and the major axis and the minor axis of each ellipse were measured. The minor axes of the ellipses of all of the particles in the SEM image were averaged to calculate the average ellipse minor axis (nm).

### 4-3. Proportion of Number of Fine Particles

Particles having a 75% or less particle size with respect to the average ellipse minor axis obtained by the ellipse approximation in section 4-2 above were defined as fine particles, and the total number of particles and the number of fine particles in the SEM image were counted. The ratio of the number of fine particles to the total number of particles was calculated ((Number of fine particles/Total number of particles)×100(%)).

### 4-4. Aspect Ratio

The ratio of the major axis of the ellipse to the minor axis of the ellipse (Ellipse major axis/Ellipse minor axis) of each particle was calculated from the ellipse major axis and the ellipse minor axis obtained by the ellipse approximation in section 4-2 above, and the average value was defined as the aspect ratio.

### 5. Surface Roughness

The (B1/S1) obtained by dividing the BET specific surface area (B1) by the specific surface area (S1) calculated from the average ellipse minor axis was defined as the surface roughness. The specific surface area (S1) was determined by converting the value of 2727/average ellipse minor axis (nm) with the true specific gravity of the silica taken as 2.2.

### 6. Density of Silanol Groups

The density of silanol groups of the silica particles was measured by the Sears method. The Sears method was carried out with reference to the description in G. W. Sears, Jr., “Determination of Specific Surface Area of Colloidal Silica by Titration with Sodium Hydroxide,” Analytical Chemistry, 28 (12), 1981 (1956). For the measurement, the titration was performed with a 0.1 mol/L aqueous sodium hydroxide solution using a 1 mass % silica dispersion, and the density of silanol groups was calculated in accordance with the following formula:

$$ρ = ( a \times f \times 6022 ) / ( c \times S ) .$$

In the formula above, ρ represents the density of silanol groups (groups/nm²), a represents the amount of droplets of the 0.1 mol/L aqueous sodium hydroxide solution having a pH of 4 to 9 (mL), f represents the factor of the 0.1 mol/L aqueous sodium hydroxide solution, c represents the mass of the silica particles (g), and S represents the BET specific surface area (m²/g)

### 7. True Density

The colloidal silica was dried on a 150° C. hot plate, and then heat-treated at 300° C. for 1 hour. Then, the true density was measured by a measurement method including measuring the true density by a liquid phase displacement method using ethanol.

### 8. Zeta Potential

The colloidal silica was diluted with a 10 mM aqueous sodium chloride solution so that the silica concentration was 1 mass %, and the zeta potential was measured using an ELS-Z manufactured by Otsuka Electronics Co., Ltd.

1. Colloidal silica in which a silyl group having one or more amino groups is introduced inside particles, wherein
the proportion of the number of fine particles contained in the colloidal silica is less than 5% based on the total number of particles, and
the density of silanol groups on the surface of the particles of the colloidal silica is 4.0 groups/nm² or less.

2. The colloidal silica according to claim 1, wherein the true density is 1.90 or more.

3. A method for producing colloidal silica in which a silyl group having one or more amino groups is introduced inside particles,
the method comprising:
allowing an alkoxysilane having one or more groups and an alkoxysilane not having an amino group to react with core particles in the presence of an alkaline catalyst to form shells, wherein
the total amount of the alkoxysilanes added in a shell formation reaction is 200 times or more in terms of molar ratio with respect to the amount of the alkaline catalyst present in a reaction system in the shell formation reaction.
